(19) United States
(12) Patent Application Publication
(10) Pub. No.: US 2005/0274215 A1
(43) Pub. Date: Dec. 15, 2005

(54) Worm gear assembly having improved physical properties and method of making same

(76) Inventors: Geoff Bishop, Hartville, OH (US); Carl Ribaudo, Jackson, OH (US); Craig Darragh, Jackson, OH (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/867,629

(22) Filed: Jun. 15, 2004

(51) Int. Cl. F16H 1/16

(52) U.S. Cl. 74/425

(57) ABSTRACT

The ability of a worm assembly to resist adhesive and/or abrasive wear, hertzian contact fatigue, and bending fatigue are enhanced by selecting a worm shaft produced from a hardened steel which will maintain the tooth geometry of the worm tooth during service; selecting a worm gear made from a work-hardening metal (such as austenitic steel, a microalloyed steel, wrought steel, compacted metal powder, or cast iron); imparting a finish to the worm and/or worm gear and/or applying a tribological coating containing metal carbides dispersed in an amorphous hydrocarbon or silicon matrix to the worm and/or worm gear.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

This invention relates to methods of forming worms and worm gears to enhance the properties of the worm and worm gear. In particular, the invention relates to combinations of materials and coatings for the worm and worm gear.

The relative commercial usefulness of worm gear systems is based upon (1) the power rating of the system; (2) the mechanical efficiency of the system; and (3) the cost to produce the system. Optimal material selection for the worm and gear, in turn, requires the simultaneous consideration of several criteria. These criteria include: (1) prevention of adhesive and abrasive wear; (2) mesh friction losses; (3) geometric conformity between the gear and worm; (4) mechanical strength limits of the gear and worm; (5) the costs of the raw materials for the gear and worm; and (6) the costs to produce the gear and worm.

Currently, these criteria are typically met by using a bronze gear whose teeth have been hobbed without additional machining or other finishing and a hardened steel worm whose threads or teeth have been rolled and/or ground. The issues of adhesive and abrasive wear and mesh frictional losses are more significant for worm gearing than other types of gears because of the high degree of sliding contact between worm and gear. The chemical dissimilarity between the bronze and steel provides much greater resistance to adhesive wear and lower mesh frictional losses than if either alloy were used for both components. Lower mesh friction losses increase mechanical efficiency and power ratings based upon thermal limits. Since the bronze is soft enough to undergo plastic deformation and abrasive wear during initial service, the profile of the teeth can change to become sufficiently conformable with the worm. In addition, the surface texture of the gear teeth is typically improved by the polishing action of the hardened steel worm. As a consequence, a bronze gear may be formed in a single hobbing operation instead of multiple operations so that manufacturing costs are minimized. On the other hand, the thread(s) of the worm are rolled and/or ground to optimize the thread profile and surface texture since these will not be substantially altered by contact with the softer gear. The relatively low strength of the bronze typically establishes the mechanical limit for the power rating since transfer of the bronze from the gear to the worm must be prevented along with gear tooth breakage. The use of a stronger bronze alloy increases the mechanical limit, but reduces the conformability of the worm gear flanks and may cause abrasive wear of the worm.

It is desirable to further improve the performance of worm gear systems.

### BRIEF SUMMARY OF THE INVENTION

Briefly stated, the properties of a worm assembly are enhanced by selecting a worm shaft produced from a hardened steel which will maintain the tooth geometry of the worm tooth during service; selecting a worm gear made from a work-hardening metal which will allow the gear teeth geometry to deform to conform to the worm tooth geometry during service while plastically work-hardening during service; and imparting a finish to the worm and/or worm gear to provide resistance to adhesive and abrasive wear, hertzian contact fatigue, and bending fatigue.

The finish imparted to the teeth of the worm and/or worm gear can be accomplished by vibratory processing, hard turning, honing, rolling, or combinations thereof.

The steel used for the worm can be hardened by a sequence of heating to achieve reaustenization, quenching and tempering. The worm can be heated in a furnace, or by a laser, electron beam, magnetic induction, visible light, or by combinations thereof. The worm can then be quenched in a hydrocarbon based liquid, an aqueous based liquid, air, a partial vacuum, or inert gas. Alternatively, the worm can be carburized to develop a carbon concentration gradient prior to quenching and tempering to produce high surface and subsurface hardness levels while retaining high toughness in the core of the worm. Similarly, the worm can be carbonitrided to develop carbon and nitrogen concentration gradients prior to quenching and tempering to produce high surface and subsurface hardness levels while retaining high toughness in the core of the worm. The carburizing or carbonitriding can be carried out using gas-based processes, solid pack diffusion processes, ion processes or vacuum processes.

Alternatively, the worm can be nitrided to produce a nitrogen concentration gradient and high surface and subsurface hardness levels while retaining high toughness in the core of the worm. Similarly, the worm can be nitrocarburized to develop nitrogen and carbon concentration gradients which produce high surface and subsurface hardness levels while retaining high toughness in the core of the worm. The nitriding or nitrocarburizing process can be carried out after quenching and tempering or after normalizing and tempering. The nitriding or nitrocarburizing can be carried out using gas-based processes, salt-bath process, ion processes or vacuum processes.

The work-hardening metal from which the gear is made can be austenitic steel, a microalloyed steel, wrought steel, compacted metal powder, or cast iron. The austenitic steel can be a manganese austenitic steel containing about 10% to about 15% manganese. In one embodiment, the manganese austenitic steel contains about 12% manganese. The austenitic steel can also be modified to contain about 1% C, about 1% N, about 2-4% Al, and combinations thereof. The microalloyed steel can be a steel microalloyed with V, Ti, Nb, or combinations thereof. The cast iron can be gray iron, malleable iron, or ductile iron. The gear can be subject to mechanical and/or thermal treatments. Mechanical treatments include shotpeening of the gear. Thermal treatments include treatment by laser, electron beam, and visible light.

In another aspect of the invention, the teeth of the worm and/or the worm gear are coated with a tribological coating. The coating may contain metal carbides dispersed in an amorphous hydrocarbon-based or silicon-based matrix. The metal carbides may be nanocrystalline Ti and/or W carbides. The coating can be applied to have a thickness of about 1-3 micrometer. The coating can be applied by physical vapor deposition, and/or plasma enhanced physical vapor deposition, and/or any other method that will enable the coating to adhere to the worm and/or gear teeth. The coating which is applied to the gear teeth can be the same as, or different from, the coating applied to the worm teeth.

### BRIEF DESCRIPTION OF THE SEVERAL VIEWS OF THE DRAWINGS

FIG. 1 is an illustrative drawing of a worm assembly; and

FIG. 2 is an enlarged fragmentary side elevational view of a gear tooth.

Corresponding reference numerals will be used throughout the several figures of the drawings.

### DETAILED DESCRIPTION OF THE INVENTION

The following detailed description illustrates the invention by way of example and not by way of limitation. The description will clearly enable one skilled in the art to make and use the invention, and describes several embodiments, adaptations, variations, alternatives and uses of the invention, including what we presently believe is the best mode of carrying out the invention. Additionally, it is to be understood that the invention is not limited in its application to the details of construction and the arrangements of components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

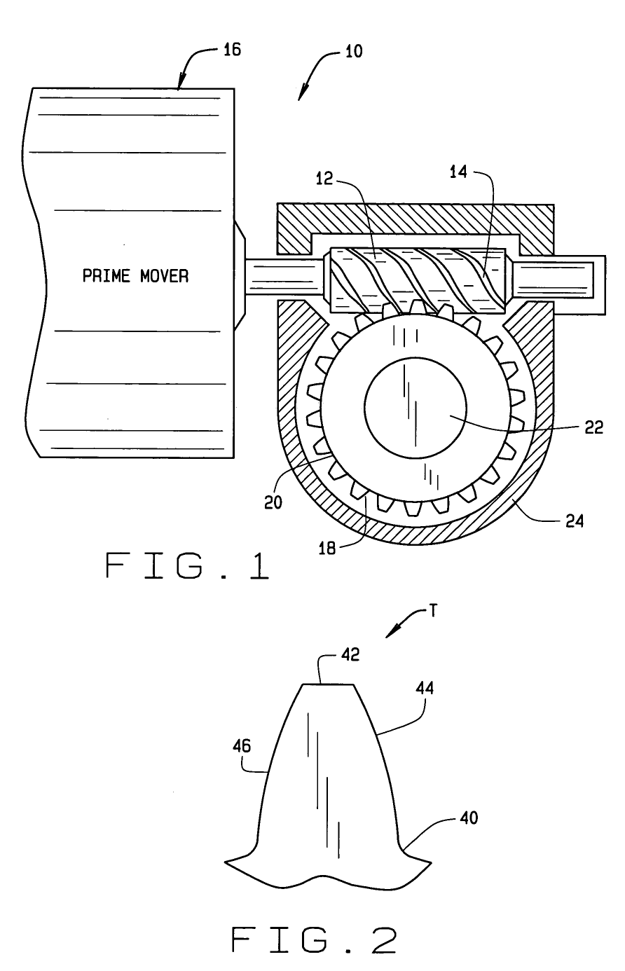

A worm assembly 10 is shown generally in FIG. 1. The worm assembly includes a worm input shaft 12 having spiraling worm teeth 14. The input shaft 12 is connected to a prime mover 16, such as a motor. The worm teeth 14 mesh with the teeth 18 of a worm gear or gear wheel 20. An output shaft 22 extends from the center of the worm gear 20 to be rotated by the worm gear. The worm input shaft 12 and the worm gear 20 are contained within a housing 24, and the input and output shafts extend from the housing to be connected to a driver 16 and a driven element (not shown). Although the driver 16 is shown being connected to the worm input shaft, it could alternatively be connected to the worm gear 20, such that the worm gear 20 drives the worm shaft 12.

In one aspect of the invention, the teeth of the worm 12 or the gear 20 (or both) are coated with a tribological coating after a surface finishing treatment. A typical gear tooth T is shown FIG. 2. A tooth, as is known, includes a tooth root 40, a tooth tip 42, a leading surface 44, and a trailing surface 46. The coating can be applied to at least the flank surfaces of the tooth (whether the tooth be a gear tooth or a worm tooth) or to all surfaces of the tooth. The coating can be about 1-3 micrometer thick and can be applied via physical vapor deposition, and/or plasma enhanced physical vapor deposition, and/or any other method that will adhere the coating to the surface of the worm or worm gear. The use of the tribological coating in the worm system will provide protection against adhesive wear and promote low mesh frictional losses. The tribological coating can be a thin solid carbide film with an amorphous matrix containing about 0% to about 45% hydrogen and/or about 0% to about 35% of one or more metallic elements such as Ti, W, Cr, Ta, or Si. If present in the film, the metallic elements may or may not be present within carbide phases. The carbide phases could occupy about 0 to about 0.95 volume fraction of the microstructure. The film may contain multiple layers that vary in composition and microstructure. For example, an approximately 50 to approximately 400 nanometer thick bond-layer consisting of Ti, Cr, Si, or W may be applied directly to the substrate to establish strong coating adhesion. A pseudodiffusion inter-layer with a thickness of about 50 to about 1000 nanometers may then be applied to transition gradually between the adhesive bond-layer and the functional top-layer compositions. The functional top-layer that comprises most of the coating thickness is deposited as a final step. The coating, which is described below, for the worm can be the same as, or different than, the coating used for the gear.

In another aspect of the invention, the worm system performance is improved by an integrated selection of materials and processes. A first illustrative approach would be to employ a work-hardening steel gear (i.e., a gear made from a steel which hardens during service or use) and a hardened steel worm with a tribological coating applied to the worm. In this approach, the relatively low hardness of the steel gear would allow sufficient plastic flow to occur so that conformance between the worm and gear is established at the start of service. The work-hardening of the steel gear would increase the mechanical power rating of the gear. The work-hardened steel may be a commercially available alloy or an alloy developed specifically for the specific application. A commercially available steel could be an austenitic manganese steel that contains about 1.2% C and about 10% to about 15% Mn (a “Hadfield” steel) or a microalloyed steel. The Hadfield steel can be modified with carbon, nitrogen, aluminum, or combinations thereof. For example, it can include about 1% carbon, about 1% nitrogen, or about 2%-4% aluminum. A microalloyed steel can contain vanadium, titanium, niobium, or combinations thereof. For example, the microalloyed steel can contain about 0.05 to about 0.20% weight V, and/or about 0.05 to about 0.20% weight Ti, and/or about 0.05 to about 0.20% weight Nb. The use of microalloyed steel or austenitic steel for the gear enables the gear to harden during service. The steel used for the worm can be hardened by a sequence of heating for reaustenization, quenching and tempering. The steel can be heated in a furnace, or by a laser, electron beam magnetic induction or visible light. The parts can be quenched in a hydrocarbon based or aqueous based liquid, in air, in a partial vacuum, or in an inert gas.

Another approach would be to use a steel gear with a tribological coating and a hardened steel worm. In this second approach, the gear would be made from either wrought steel or compacted metal powder(s). In either instance, prior to coating the gear with the tribological coating, the gear would be manufactured to have conformance with the worm. The mechanical properties of the gear can be optimized by thermal and/or mechanical treatments. For example, if the gear is manufactured from powdered metal, its properties can be improved by shotpeening and/or by laser, electron beam, or visible light treatment.

A third approach would be to use a cast iron gear with a tribological coating and a hardened steel worm. In this third approach, the cast iron gear would be made from gray iron, malleable iron, or ductile iron. Prior to coating the gear with the tribological coating, the gear would be manufactured to have conformance with the worm. The mechanical properties of the cast iron gear can be optimized by thermal and/or mechanical treatments. The advantage of cast iron is reduced material costs relative to bronze and increased mechanical strength.

The surface texture of the gear and the worm in a worm system would be selected to optimize the characteristics of the worm and gear. The surface of the teeth on either (or both of) the worm and the worm gear can be finished via vibratory processing, hard turning, honing or rolling.

Proper selection of worm and worm gear material, and/or surface finish, and/or coating enhancements will significantly increase a worm gear speed reducer's power throughput capacity, improve its reliability, reduce an end-user's life cycle costs, and/or reduce an end-user's manufacturing costs. For an illustrative example, a typical worm gear speed reducer is designed such that a steel worm transmits power to a bronze gear via the tooth mesh. The bronze gear material inhibits galling of the steel worm. The mechanical rating of this speed reducer is limited by the shear strength of the bronze gear teeth. Changing the gear material from bronze to steel will increase the mechanical rating of the speed reducer by increasing the shear strength of the gear teeth by almost by an order of magnitude. The enhanced gear tooth finish and coating thereof prevents galling of the steel worm and steel gear subject to the higher loads enabled by the higher speed reducer rating.

As various changes could be made in the above constructions without departing from the scope of the invention, it is intended that all matter contained in the above description or shown in the accompanying drawings shall be interpreted as illustrative and not in a limiting sense.

1. A worm assembly comprising a worm and a worm gear contained within a housing; wherein
the worm is produced from hardened steel;
the worm gear is produced from an austenitic steel, a microalloyed steel, wrought steel, compacted metal powder, or cast iron; and
at least one of the worm and worm gear is coated with a tribological coating, the coating comprising metal carbides contained in an amorphous hydrogenated matrix.

2. The worm assembly of claim 1 wherein the gear contains at least some austenite.

3. The worm assembly of claim 1 wherein the steel for the worm shaft is hardened by a sequence of heating to produce reaustenization in the worm shaft, quenching and tempering.

4. The worm assembly of claim 1 wherein the worm shaft is heated in a furnace, by a laser, by an electron beam, by magnetic induction, by visible light, or by combinations thereof.

5. The worm assembly of claim 1 wherein the worm shaft is quenched in a hydrocarbon based liquid, in an aqueous based liquid, in air, in a partial vacuum, or in an inert gas.

6. The worm assembly of claim 1 wherein the worm has been carburized or carbonitrided.

7. The worm assembly of claim 6 wherein the worm has been carburized or carbonitrided using a gas-based process, solid pack diffusion process, ion process or vacuum process.

8. The worm assembly of claim 1 wherein the worm has been nitrided or nitrocarburized.

9. The worm assembly of claim 8 wherein the worm has been nitrided or nitrocarburized using a gas-based process, salt-bath process, ion process or vacuum process.

10. The worm assembly of claim 1 wherein the steel for the worm gear is selected from a work hardening steel.

11. The worm gear assembly of claim 1 wherein the work hardening steel is selected from an austenitic manganese steel or a microalloyed steel.

12. The worm gear assembly of claim 11 wherein the austenitic manganese steel is modified with aluminum, nitrogen, or combinations thereof.

13. The worm gear assembly of claim 11 wherein the austenitic manganese steel contains about 1.2% C and about 12% Mn.

14. The worm gear assembly of claim 1 wherein the iron for the gear is chosen from gray iron, malleable iron, or ductile iron.

15. The worm gear assembly of claim 1 wherein the carbides in the coating contain Ti, W, Cr, Ta, Si, or combinations thereof.

16. The worm gear assembly of claim 1 wherein the carbides in the coating are nanocrystalline.

17. The worm gear assembly of claim 1 wherein the coating is a Ti, W, Cr, Ta, or Si matrix.

18. A method of producing a worm assembly comprising:
selecting a worm shaft made from hardened steel;
selecting a worm gear made from a work-hardening steel, compacted metal powder, or cast iron;
finishing the surface of the teeth of at least one of the worm shaft and the worm gear; and
coating the teeth of at least one of the worm shaft and the worm gear with a tribological coating.

19. The method of claim 18 wherein the finishing step is performed by vibratory processing, hard turning, honing, rolling, or combinations thereof.

20. The method of claim 18 wherein the steel for the worm shaft is hardened by a sequence of heating to produce reaustenization in the worm shaft, quenching and tempering.

21. The method of claim 18 wherein the worm shaft is heated in a furnace, by a laser, by an electron beam, by magnetic induction, by visible light, or by combinations thereof.

22. The method of claim 18 wherein the worm shaft is quenched in a hydrocarbon based liquid, in an aqueous based liquid, in air, in a partial vacuum, or in an inert gas.

23. The method of claim 18 including a step of carburizing or carbonitriding the worm.

24. The method of claim 23 wherein the step of carburizing or carbonitriding the worm is performed using a gas-based process, solid pack diffusion process, ion process or vacuum process.

25. The method of claim 18 including a step of nitriding or nitrocarburizing the worm.

26. The method of claim 25 wherein the step of nitriding or nitrocarburizing the worm is performed using a gas-based processes, salt-bath process, ion process or vacuum process.

27. The method of claim 18 wherein the gear is subject to deformation by shotpeening, laser, electron beam, visible light, or combinations thereof.

28. The method of claim 18 wherein the steel for the worm gear is austenitic steel modified with aluminum and/or nitrogen.

29. The method of claim 18 wherein the steel for the worm gear is a microalloyed steel which is microalloyed with V, Ti, Nb, or combinations thereof.

30. The method of claim 18 wherein the tribological coating is applied to a depth of about 1-3 micrometer.

31. The method of claim 18 wherein the tribological coating contains metallic or silicon carbides dispersed in an amorphous hydrocarbon-based matrix.

32. A method of producing a worm assembly comprising:
selecting a worm shaft made from hardened steel;
selecting a worm gear made from a work-hardening steel, compacted metal powder, or cast iron; and
finishing the surface of the teeth of at least one of the worm shaft and the worm gear.

33. The method of claim 32 wherein the step of finishing is performed by vibratory processing, hard turning, honing, rolling, or combinations thereof.

34. The method of claim 32 wherein the steel for the worm shaft is hardened by a sequence of heating to produce reaustenization in the worm shaft, quenching and tempering.

35. The method of claim 32 including a step of carburizing or carbonitriding the worm.

36. The worm assembly of claim 35 wherein the step of carburizing or carbonitriding worm is performed using a gas-based process, solid pack diffusion process, ion process or vacuum process.

37. The process of claim 32 including a step of nitriding or nitrocarburizing the worm.

38. The method of claim 37 wherein the step of nitriding or nitrocarburizing the worm is performed using a gas-based process, salt-bath process, ion process or vacuum process.

39. The method of claim 32 including a step of subjecting the gear to deformation by shotpeening, laser, electron beam, visible light, or combinations thereof.

40. The method of claim 32 wherein the steel for the gear is an austenitic steel which is modified with aluminum and/or nitrogen.

41. The method of claim 32 wherein the steel for the gear is microalloyed steel which is microalloyed with V, Ti, Nb, or combinations thereof.
